(19) United States
(12) Patent Application Publication
(10) Pub. No.: US 2023/0323100 A1
(43) Pub. Date: Oct. 12, 2023

(54) IMPACT MODIFIED POLYPROPYLENE COMPOSITION, ARTICLES AND METHOD OF PREPARING SAME

(71) Applicant: Braskem S.A., Camaçari (BR)

(72) Inventors: Hadi Mohammadi, Philadelphia, PA (US); Nei Sebastião Domingues Junior, São Paulo City (BR); Kevin Herrington, Philadelphia, PA (US); Sharareh Asiaee, Wesseling (DE)

(73) Assignee: Braskem S.A., Camaçari (BR)

(21) Appl. No.: 18/296,719

(22) Filed: Apr. 6, 2023

Related U.S. Application Data
(60) Provisional application No. 63/328,045, filed on Apr. 6, 2022.

(51) Int. Cl. C08L 23/12

(52) U.S. Cl. CPC C08L 23/12

(57) ABSTRACT

A polymer composition contains a polypropylene-based polymer, a vinyl ester containing copolymer which includes ethylene, one or more branched vinyl ester monomers, and optionally, vinyl acetate. A method for producing a polymer composition includes mixing a polypropylene-based polymer and a vinyl ester containing copolymer at a temperature in a range from 20° C. to 300° C. to form the polymer composition. An article contains the polymer composition.

### BACKGROUND

Polypropylene (PP) compositions have gained wide commercial acceptance and usage in numerous applications because of the relatively low cost of the polymers and the desirable properties they exhibit. The application of PP includes packaging, household products, automotive interior and exterior parts, and construction. Although PP possesses properties such as good processability, high melting temperature, and high chemical resistance. PP in general is brittle, has low mechanical performance and low impact resistance particularly below or around its glass transition temperature (Tg). To combat these issues, manufacturers have incorporated various additives and modifiers, such as ethylene-vinyl acetate (EVA) and ethylene propylene diene monomer (EPDM) to improve the properties of PP, particularly the impact resistance.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a polymer composition containing a polypropylene-based polymer, a vinyl ester containing copolymer which includes ethylene, one or more branched vinyl ester monomers, and optionally, vinyl acetate.

In another aspect, embodiments disclosed herein relate to a method for producing a polymer composition including mixing a polypropylene-based polymer and a vinyl ester containing copolymer, at a temperature in a range from 20° C. to 300° C. to form a polymer composition, wherein the vinyl ester containing copolymer comprises ethylene, one or more branched vinyl ester monomers, and optionally, vinyl acetate.

In yet another aspect, embodiments disclosed herein relate to an article containing the polymer composition.

Other aspects and advantages of the claimed subject matter will be apparent from the following description and the appended claims.

### BRIEF DESCRIPTION OF THE DRAWINGS

FIG. 1 is a schematic diagram of an exemplary extruder to produce a polymer composition in accordance with one or more embodiments.

FIG. 2 is a tan delta vs. temperature graphs of polymer compositions of EXAMPLES 1-2 in accordance with one or more embodiments, and REFERENCE EXAMPLE 1, obtained by dynamic mechanical analysis.

FIG. 3 is a tan delta vs. temperature graphs of polymer compositions of EXAMPLES 3-4 in accordance with one or more embodiments, and REFERENCE EXAMPLE 2, obtained by dynamic mechanical analysis.

FIG. 4 is a tan delta vs. temperature graph of polymer compositions of EXAMPLES 5-6 in accordance with one or more embodiments, and REFERENCE EXAMPLE 2, obtained by dynamic mechanical analysis.

FIG. 5A is an SEM image of the REFERENCE EXAMPLE 2.

FIG. 5B is an SEM image of the polymer composition of EXAMPLE 3 in accordance with one or more embodiments.

FIG. 5C is an SEM image of the polymer composition of EXAMPLE 4 in accordance with one or more embodiments.

### DETAILED DESCRIPTION

In one aspect, embodiments disclosed relate to polymer compositions that include a polypropylene-based polymer, a vinyl ester containing copolymer comprising ethylene, one or more branched vinyl ester monomers and optionally, vinyl acetate.

In one or more embodiments, polymer compositions may include a percent by weight of a polypropylene-based polymer that ranges from a lower limit selected from any of 60 wt %, 65 wt % and 70 wt % to an upper limit selected from any of 80 wt %, 85 wt %, 90 wt %, 95 wt %, and 99 wt % where any lower limit may be paired with any upper limit.

In one or more embodiments, polymer compositions may include a percent by weight of a vinyl ester containing copolymer that ranges from a lower limit selected from any of 1 wt %, 2 wt %, 3 wt %, 4 wt % and 5 wt % to an upper limit selected from any of 25 wt %, 30 wt %, 35 wt % and 40 wt %, where any lower limit may be paired with any upper limit.

### Polypropylene-Based Polymer

Polymer compositions of the present disclosure may include a polypropylene-based polymer which may be a polypropylene homopolymer or a propylene copolymer. In one or more embodiments, the propylene copolymer may include propylene and 40 wt % or less of comonomer selected from any of one or more of ethylene and C4 to C10 alkenes, including linear monomers such as alpha-olefins and comonomers with various degrees of branching. In one or more embodiments, propylene copolymers may include propylene and 40 wt % or less, 30 wt % or less, 20 wt % or less or 10 wt % or less of comonomers.

In one or more embodiments, polymer compositions may include a polypropylene-based polymer which is a “heterophasic polypropylene”. Heterophasic polypropylene is defined as polypropylene containing a continuous matrix (continuous phase or matrix polymer) and an elastomeric rubber phase (also known as internal rubber phase or discontinuous phase) and is generated by incorporating an elastomeric rubber phase into a matrix polymer, which results in a polymer composition having modified bulk properties, including noticeable changes in impact resistance and modulus. In one or more embodiments, the matrix polymer of the heterophasic polypropylene may be a polypropylene homopolymer or a propylene copolymer. In one or more embodiments, the matrix polymer may be monomodal or bimodal. A material, such as polymer, having a single molecular weight distribution and two different molecular weight distribution are referred to as monomodal and bimodal.

In one or more embodiments, heterophasic polypropylene may contain an elastomeric rubber phase that is prepared from a propylene copolymer containing propylene and least one comonomer selected from one or more of ethylene and C4 to C10 alkenes, including linear monomers such as alpha-olefins and comonomers with various degrees of branching. Rubbers in accordance with the present disclosure may have varying compositions and molecular weight (MW). In one or more embodiments, rubbers may have a molecular weight distribution (MWD, Mw/Mn) measured by GPC-3D (3 detectors), light scattering, viscosity and infrared detector of both fractions that is equal to or greater than 10. In particular embodiments, rubbers may have a MWD that ranges from a lower limit selected from any one of 2, 4, 6, 8, 10, and 12, to an upper limit selected from any one of 20, 23, and 26, where any lower limit may be paired with any upper limit.

In one or more embodiments, the comonomer of the elastomeric rubber phase is ethylene.

In one or more embodiments, the continuous matrix is present in heterophasic polypropylene at a percent by weight (wt %) of the total heterophasic polypropylene ranging from a lower limit selected from one of 60 wt %, 65 wt %, and 70 wt %, to an upper limit selected from one of 72 wt %, 75 wt %, 80 wt %, 85 wt %, 90 wt %, 95 wt %, 99 wt % where any lower limit can be used with any upper limit.

In one or more embodiments, the elastomeric rubber phase is present in heterophasic polypropylene at a percent by weight (wt %) of the total heterophasic polypropylene ranging from a lower limit selected from any one of 1 wt %, 5 wt %, 10 wt %, 15 wt %, 20 wt %, 25 wt %, and 28 wt %, to an upper limit selected from any one of 30 wt %, 35 wt %, and 40 wt %, where any lower limit may be paired with any upper limit.

In one or more embodiments, an elastomeric rubber phase may comprise a comonomer at a percent by weight (wt %) of the total elastomeric rubber phase ranging from a lower limit selected from any one of 1 wt %, 5 wt %, 10 wt %, and 15 wt %, to an upper limit selected from any one of 25 wt %, 30 wt %, and 35 wt %, where any lower limit may be paired with any upper limit. In one or more embodiments, an elastomeric rubber phase may contain a comonomer at a wt % of equal to or less than 35 wt %. In one or more embodiments, an elastomeric rubber phase may contain a comonomer at a wt % of equal to or less than 5 wt %. In one or more embodiments, an elastomeric rubber phase may contain an ethylene comonomer at a wt % of equal to or less than 35 wt %.

In one or more embodiments, heterophasic polypropylene may be prepared in a multistage polymerization process. In one or more embodiments, a matrix polymer may be produced in a first and second reactor and a discontinuous rubber phase may be produced using two or more gas phase reactors. heterophasic polypropylene may be prepared using any suitable catalyst, such as a Ziegler-Natta catalyst, metallocene catalysts or other single site catalysts. In one or more embodiments, the melt flow rate (MFR) of the matrix polymer may be controlled by adjusting the concentration of hydrogen gas present in the first reactors and available for interaction with a Ziegler-Natta catalyst in accordance with known polymerization methods. After the polymerization, heterophasic polypropylene may be visbroken with any suitable peroxide agent to achieve a target MFR.

Following heterophasic polypropylene synthesis, heterophasic polypropylene may be visbroken by adding a visbreaking agent, such as a peroxide agent, to the copolymer during extrusion to increase its melt flow rate. The visbreaking can be carried out in a pelletizing extruder in one or more embodiments, and may be pelletized prior to visbreaking in one or more embodiments. For example, a solution of peroxide in mineral oil or alcohol can be mixed with a heterophasic polypropylene or may be added to the heterophasic polypropylene at the throat of an extruder.

Extrusion temperatures will depend, at least in part, on the visbreaking agent employed. In one or more embodiments, the visbreaking temperature should be high enough to ensure that the visbreaking agent reacts during the visbreaking process. In one or more embodiments, extruder temperatures during visbreaking may be equal to or greater than 120 C.

### Vinyl Ester Containing Copolymers

In one or more embodiments, polymer compositions may include a vinyl ester containing copolymer comprising ethylene, one or more branched vinyl ester monomers and optionally, vinyl acetate.

Embodiment polymer compositions may include a vinyl ester containing copolymer incorporating various ratios of ethylene and one or more branched vinyl esters. In one or more embodiments, a vinyl ester containing copolymer may be prepared by reacting ethylene and a one or more branched vinyl ester in the presence of additional comonomers and one or more radical initiators to form a copolymer. In other embodiments, the polymer compositions may include a vinyl ester containing copolymer that is a terpolymer. The terpolymer may be prepared by reacting ethylene with a first comonomer to form a polymer resin or prepolymer, and then reacted with a second comonomer to prepare the final polymer composition, wherein the first and the second comonomer can be added in the same reactor or in different reactors. In one or more embodiments, the first comonomer may be one of more branched vinyl ester and the second comonomer may be vinyl acetate.

In one or more embodiments, vinyl ester containing copolymers may include a percent by weight of ethylene, based on the total weight of the vinyl ester containing polymers and measured by proton nuclear magnetic resonance (1H NMR) and Carbon 13 nuclear magnetic resonance (13C NMR), that ranges from a lower limit selected from one of 10 wt %, 20 wt %, or 30 wt %, to an upper limit selected from one of 60 wt %, 70 wt %, 80 wt %, 90 wt %, 95 wt %, 99.9 wt %, and 99.99 wt % where any lower limit may be paired with any upper limit.

In one or more embodiments, vinyl ester containing copolymers may include branched vinyl ester monomers generated from isomeric mixtures of branched alkyl acids. Branched vinyl esters in accordance with the present disclosure may have the general structure (I):

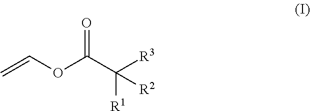

where R¹, R², and R³ have a combined carbon number in the range of C3 to C20. In one or more embodiments, R¹, R², and R³ may all be alkyl chains having varying degrees of branching in one or more embodiments, or a subset of R¹, R², and R³ may be independently selected from a group consisting of hydrogen, alkyl, or aryl in one or more embodiments.

In one or more embodiments, vinyl ester containing copolymers may include branched vinyl ester monomers having the general structure (II):

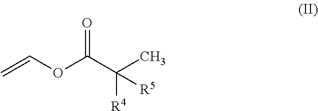

wherein R⁴ and R⁵ have a combined carbon number of 6 or 7 and the polymer composition has a number average molecular weight (Me) ranging from 5 kDa to 10000 kDa obtained by GPC. In one or more embodiments, R⁴ and R⁵ may have a combined carbon number of less than 6 or greater than 7, and the polymer composition may have an Mₙ up to 10000 kDa. That is, when the Mₙ is less than 5 kDa, R⁴ and R⁵ may have a combined carbon number of less than 6 or greater than 7, but if the Mₙ is greater than 5 kDa, such as in a range from 5 to 10000 kDa, R⁴ and R⁵ may include a combined carbon number of 6 or 7. In particular embodiments, R⁴ and R⁵ have a combined carbon number of 7, and the Mₙ may range from 5 to 10000 kDa. Further in one or more particular embodiments, a vinyl ester according to Formula (II) may be used in combination with vinyl acetate.

Examples of branched vinyl ester monomers may include monomers having the chemical structures, including derivatives thereof:

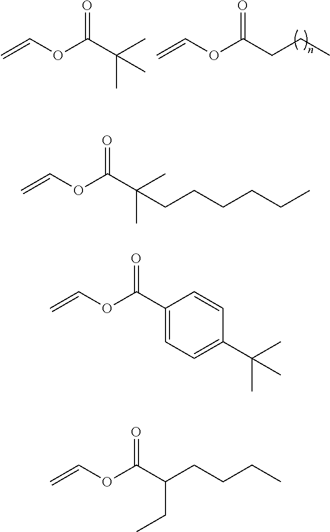

In one or more embodiments, branched vinyl ester monomers may include monomers and comonomer mixtures containing vinyl esters of neononanoic acid, neodecanoic acid, and the like. In one or more embodiments, branched vinyl esters may include Versatic™ acid series tertiary carboxylic acids, including Versatic™ acid EH, Versatic™ acid 9 and Versatic™ acid 10 prepared by Koch synthesis, VeoVa 9™, VeoVa 10™, VeoVa EH™ commercially available from Hexion™ chemicals. In one or more embodiments, vinyl ester containing copolymers may include branched vinyl ester monomers generated from monomers derived from petroleum and/or renewable sources.

In one or more embodiments, vinyl ester containing copolymers may include a percent by weight of a branched vinyl ester monomer, such as that of Formula (I) and (II) above, based on the total weight of the vinyl ester containing copolymer and measured by ¹H NMR and ¹³C NMR, that ranges from a lower limit selected from any of 0.01 wt %, 0.1 wt %, 1 wt %, 5 wt %, 10 wt %, 20 wt %, and 30 wt % to an upper limit selected from any of 50 wt %, 60 wt %, 70 wt %, 80 wt %, 89.99 wt %, and 90 wt % where any lower limit may be paired with any upper limit.

In one or more embodiments, vinyl ester containing copolymers may optionally include a percent by weight of vinyl acetate, based on the total weight of the vinyl ester containing copolymer and measured by ¹H NMR and ¹³C NMR, that ranges from a lower limit selected from any of 0 wt %, 0.01 wt %, 0.1 wt %, 1 wt %, 5 wt %, 10 wt %, 20 wt %, and 30 wt % to an upper limit selected from any of 50 wt %, 60 wt %, 70 wt %, 80 wt %, and 89.99 wt % where any lower limit may be paired with any upper limit.

In one or more embodiments, vinyl ester containing copolymers may have a number average molecular weight (Me) in kilodaltons (kDa) measured by gel permeation chromatography (GPC) that ranges from a lower limit selected from any of 1 kDa, 5 kDa, 10 kDa, 15 kDa, and 20 kDa to an upper limit selected from any of 40 kDa, 50 kDa, 100 kDa, 300 kDa, 500 kDa, 1000 kDa, 5000 kDa, and 10000 kDa, where any lower limit may be paired with any upper limit.

In one or more embodiments, vinyl ester containing copolymers may have a molecular weight distribution (MWD, defined as the ratio of M_{w} over Mₙ) measured by GPC that has a lower limit of any of 1, 2, 5, or 10, and an upper limit of any of 20, 30, 40, 50, or 60, where any lower limit may be paired with any upper limit.

In one or more embodiments, vinyl ester containing copolymers may have a weight average molecular weight (Mw) in kilodaltons (kDa) measured by GPC that ranges from a lower limit selected from any of 1 kDa, 5 kDa, 10 kDa, 15 kDa and 20 kDa to an upper limit selected from any of 40 kDa, 50 kDa, 100 kDa, 200 kDa, 300 kDa, 500 kDa, 1000 kDa, 2000 kDa, 5000 kDa, 10000 kDa, and 20000 kDa, where any lower limit may be paired with any upper limit.

In one or more embodiments, vinyl ester containing copolymer may include one or more initiators for radical polymerization capable of generating free radicals that initiate chain polymerization of comonomers and prepolymers in a reactant mixture. In one or more embodiments, radical initiators may include chemical species that degrade to release free radicals spontaneously or under stimulation by temperature, pH, or other triggers.

In one or more embodiments, radical initiators may include peroxides and bifunctional peroxides such as benzoyl peroxide; dicumyl peroxide; di-tert-butyl peroxide; tert-butyl cumyl peroxide; t-butyl-peroxy-2-ethyl-hexanoate; tert-butyl peroxypivalate; tertiary butyl peroxyneodecanoate; t-butyl-peroxy-benzoate; t-butyl-peroxy-2-ethyl-hexanoate; tert-butyl 3,5,5-trimethylhexanoate peroxide; tert-butyl peroxybenzoate; 2-ethylhexyl carbonate tert-butyl peroxide; 2,5-dimethyl-2,5-di (tert-butylperoxide) hexane; 1,1-di (tert-butylperoxide)-3,3,5-trimethylcyclohexane; 2,5-dimethyl-2,5-di(tert-butylperoxide) hexyne-3; 3,3,5,7,7-pentamethyl-1,2,4-trioxepane; butyl 4,4-di (tert-butylperoxide) valerate; di (2,4-dichlorobenzoyl) peroxide; di(4-methylbenzoyl) peroxide; peroxide di(tert-butylperoxyisopropyl) benzene; and the like.

Radical initiators may also include benzoyl peroxide, 2,5-di(cumylperoxy)-2,5-dimethyl hexane, 2,5-di(cumylperoxy)-2,5-dimethyl hexyne-3,4-methyl-4-(t-butylperoxy)-2-pentanol, 4-methyl-4-(t-amylperoxy)-2-pentanol, 4-methyl-4-(cumylperoxy)-2-pentanol, 4-methyl-4-(t-butylperoxy)-2-pentanone, 4-methyl-4-(t-amylperoxy)-2-pentanone, 4-methyl-4-(cumylperoxy)-2-pentanone, 2,5-dimethyl-2,5-di(t-butylperoxy)hexane, 2,5-dimethyl-2,5-di(t-amylperoxy)hexane, 2,5-dimethyl-2,5-di(t-butylperoxy)hexyne-3, 2,5-dimethyl-2,5-di(t-amylperoxy)hexyne-3, 2,5-dimethyl-2-t-butylperoxy-5-hydroperoxyhexane, 2,5-dimethyl-2-cumylperoxy-5-hydroperoxy hexane, 2,5-dimethyl-2-t-amylperoxy-5-hydroperoxyhexane, m/p-alpha, alpha-di[(t-butylperoxy)isopropyl]benzene, 1,3,5-tris(t-butylperoxyisopropyl)benzene, 1,3,5-tris(t-amylperoxyisopropyl)benzene, 1,3,5-tris(cumylperoxyisopropyl)benzene, di[1,3-dimethyl-3-(t-butylperoxy)butyl]carbonate, di[1,3-dimethyl-3-(t-amylperoxy)butyl]carbonate, di[1,3-dimethyl-3-(cumylperoxy)butyl]carbonate, di-t-amyl peroxide, t-amyl cumyl peroxide, t-butyl-isopropenylcumyl peroxide, 2,4,6-tri(butylperoxy)-s-triazine, 1,3,5-tri[1-(t-butylperoxy)-1-methylethyl]benzene, 1,3,5-tri-[(t-butylperoxy)-isopropyl]benzene, 1,3-dimethyl-3-(t-butylperoxy)butanol, 1,3-dimethyl-3-(t-amylperoxy)butanol, di(2-phenoxyethyl)peroxydicarbonate, di(4-t-butylcyclohexyl)peroxydicarbonate, dimyristyl peroxydicarbonate, dibenzyl peroxydicarbonate, di(isobornyl)peroxydicarbonate, 3-cumylperoxy-1,3-dimethylbutyl methacrylate, 3-t-butylperoxy-1,3-dimethylbutyl methacrylate, 3-t-amylperoxy-1,3-dimethylbutyl methacrylate, tri(1,3-dimethyl-3-t-butylperoxy butyloxy)vinyl silane, 1,3-dimethyl-3-(t-butylperoxy)butyl N-[1-{3-(1-methylethenyl)-phenyl) 1-methylethyl]carbamate, 1,3-dimethyl-3-(t-amylperoxy)butyl N-[1-{3(1-methylethenyl)-phenyl}-1-methylethyl]carbamate, 1,3-dimethyl-3-(cumylperoxy))butyl N-[1-{3-(1-methylethenyl)-phenyl}-1-methylethyl]carbamate, 1, 1-di(t-butylperoxy)-3,3,5-trimethylcyclohexane, 1, 1-di(t-butylperoxy)cyclohexane, n-butyl 4,4-di(t-amylperoxy)valerate, ethyl 3,3-di(t-butylperoxy)butyrate, 2,2-di(t-amylperoxy)propane, 3,6,6,9,9-pentamethyl-3-ethoxycabonylmethyl-1,2,4,5-tetraoxacyclononane, n-butyl-4,4-bis(t-butylperoxy)valerate, ethyl-3,3-di(t-amylperoxy)butyrate, benzoyl peroxide, OO-t-butyl-O-hydrogen-monoperoxy-succinate, OO-t-amyl-O-hydrogen-monoperoxy-succinate, 3,6,9, triethyl-3,6,9-trimethyl-1,4,7-triperoxynonane (or methyl ethyl ketone peroxide cyclic trimer), methyl ethyl ketone peroxide cyclic dimer, 3,3,6,6,9,9-hexamethyl-1,2,4,5-tetraoxacyclononane, 2,5-dimethyl-2,5-di(benzoylperoxy)hexane, t-butyl perbenzoate, t-butylperoxy acetate, t-butylperoxy-2-ethyl hexanoate, t-amyl perbenzoate, t-amyl peroxy acetate, t-butyl peroxy isobutyrate, 3-hydroxy-1,1-dimethyl t-butyl peroxy-2-ethyl hexanoate, OO-t-amyl-O-hydrogen-monoperoxy succinate, OO-t-butyl-O-hydrogen-monoperoxy succinate, di-t-butyl diperoxyphthalate, t-butylperoxy (3,3,5-trimethylhexanoate), 1,4-bis(t-butylperoxycarbo)cyclohexane, t-butylperoxy-3,5,5-trimethylhexanoate, t-butyl-peroxy-(cis-3-carboxy)propionate, allyl 3-methyl-3-t-butylperoxy butyrate, OO-t-butyl-O-isopropylmonoperoxy carbonate, OO-t-butyl-O-(2-ethyl hexyl) monoperoxy carbonate, 1,1,1-tris[2-(t-butylperoxy-carbonyloxy)ethoxymethyl]propane, 1,1,1-tris[2-(t-amylperoxy-carbonyloxy)ethoxymethyl]propane, 1,1,1-tris[2-(cumylperoxy-carbonyloxy)ethoxymethyl]propane, OO-t-amyl-O-isopropylmonoperoxy carbonate, di(4-methylbenzoyl)peroxide, di(3-methylbenzoyl)peroxide, di(2-methylbenzoyl)peroxide, didecanoyl peroxide, dilauroyl peroxide, 2,4-dibromo-benzoyl peroxide, succinic acid peroxide, dibenzoyl peroxide, di(2,4-dichloro-benzoyl)peroxide, and combinations thereof.

In one or more embodiments, radical initiators may include azo-compounds such as azobisisobutyronitrile (AIBN), 2,2′-azobis(amidinopropyl) dihydrochloride, and the like, azo-peroxide initiators that contain mixtures of peroxide with azodinitrile compounds such as 2,2′-azobis(2-methyl-pentanenitrile), 2,2′-azobis(2-methyl-butanenitrile), 2,2′-azobis(2-ethyl-pentanenitrile), 2-[(1-cyano-1-methylpropyl)azo]-2-methyl-pentanenitrile, 2-[(1-cyano-1-ethylpropyl)azo]-2-methyl-butanenitrile, 2-[(1-cyano-1-methylpropyl)azo]-2-ethyl, and the like.

In one or more embodiments, radical initiators may include Carbon-Carbon (“C—C”) free radical initiators such as 2,3-dimethyl-2,3-diphenylbutane, 3,4-dimethyl-3,4-diphenylhexane, 3,4-diethyl-3,4-diphenylhexane, 3,4-dibenzyl-3,4ditolylhexane, 2,7-dimethyl-4,5-diethyl-4,5-diphenyloctane, 3,4-dibenzyl-3,4-diphenylhexane, and the like.

In one or more embodiments, vinyl ester containing copolymers may include one or more radical initiators present at a percent by weight of the total polymerization mixture (wt %) that ranges from a lower limit selected from any of 0.000001 wt %, 0.0001 wt %, 0.01 wt %, 0.1 wt %, 0.15 wt %, 0.4 wt %, 0.6 wt %, 0.75 wt % and 1 wt %, to an upper limit selected from any of 0.5 wt %, 1.25 wt %, 2 wt %, 4 wt %, and 5 wt %, where any lower limit can be used with any upper limit. Further, it is envisioned that the concentration of the radical initiator may be more or less depending on the application of the final material.

In one or more embodiments, vinyl ester containing copolymers may include one or more stabilizers capable of preventing polymerization in the feed lines of monomers and comonomers but not hindering polymerization at the reactor.

In one or more embodiments, stabilizers may include nitroxyl derivatives such as 2,2,6,6-tetramethyl-1-piperidinyloxy, 2,2,6,6-tetramethyl-4-hydroxy-1-piperidinyloxy, 4-oxo-2,2,6,6-tetramethyl-1-piperidinyloxy, 2,2,6,6-tetramethyl-4-amino-piperidinyloxy, and the like.

In one or more embodiments, vinyl ester containing copolymers may include ethylene based polymers polymerized in the presence of a chain transfer agent. Examples of chain transfer agents may include propylene, ethane, propane, methane, trimethylamine, dimethylamine, chloroform, and carbon tetrachloride. The chain transfer agent may be present by weight of the total composition (wt %) that ranges from a lower limit selected from one of 0.0000001 wt %, 0.000001 wt %, 0.001 wt %, 0.01 wt %, 0.02 wt %, 0.05 wt %, 1.0 wt % to an upper limit selected from one of 2.0 wt %, 3.0 wt %, 4.0 wt %, 5.0 wt %, where any lower limit can be used with any upper limit.

In one or more embodiments, vinyl ester containing copolymers may contain stabilizers present at a percent by weight of the total polymerization mixture (wt %) that ranges from a lower limit selected from any of 0.000001 wt %, 0.0001 wt %, 0.01 wt %, 0.1 wt %, 0.15 wt %, 0.4 wt %, 0.6 wt %, 0.75 wt % and 1 wt %, to an upper limit selected from any of 0.5 wt %, 1.25 wt %, 2 wt %, 4 wt %, and 5 wt %, where any lower limit may be paired with any upper limit. Further, it is envisioned that the concentration of the stabilizer may be more or less depending on the application of the final material.

In one or more embodiments, vinyl ester containing copolymers may be prepared in a reactor by polymerizing ethylene and one or more branched vinyl esters monomers. Methods of reacting the comonomers in the presence of a radical initiator may include any suitable method in the art including solution phase polymerization, pressurized radical polymerization, bulk polymerization, emulsion polymerization, and suspension polymerization.

In one or more embodiments, the reactor may be a batch or continuous reactor at pressures below 500 bar, known as low pressure polymerization system. In one or more embodiments, the reaction may be carried out in a low pressure polymerization process wherein the ethylene and one or more vinyl ester monomers are polymerized in a liquid phase of an inert solvent and/or one or more liquid monomer(s).

In one or more embodiments, polymerization may comprise initiators for free-radical polymerization in an amount from about 0.0001 to about 0.01 millimoles calculated as the total amount of one or more initiator for free-radical polymerization per liter of the volume of the polymerization zone. The amount of ethylene in the polymerization zone may depend mainly on the total pressure of the reactor in a range from about 20 bar to about 500 bar and temperature in a range from about 20° C. to about 300° C.

In one or more embodiments, the pressure in the reactor may range from a lower limit of any of 20, 30, 40, 50, 75, or 100 bar, to an upper limit of any of 100, 150, 200, 250, 300, 350, 400, 450, or 500 bar and the temperature in the reactor may range from a lower limit of any of 20° C., 50° C., 75° C. or 100° C., to an upper limit of any of 150° C., 200° C., 250° C., 300° C., where any lower limit may be paired with any upper limit.

The liquid phase of the polymerization process in accordance with the present disclosure may include ethylene, one or more vinyl ester monomer, initiator for free-radical polymerization, and optionally one or more inert solvent such as tetrahydrofuran (THF), chloroform, dichloromethane (DCM), dimethyl sulfoxide (DMSO), dimethyl carbonate (DMC), hexane, cyclohexane, ethyl acetate (EtOAc) acetonitrile, toluene, xylene, ether, dioxane, dimethyl-formamide (DMF), benzene or acetone. Copolymers and terpolymers produced under low-pressure conditions may exhibit number average molecular weights of 1 to 300 kDa, weight average molecular weights of 1 to 1000 kDa and MWDs of 1 to 60.

In one or more embodiments, the comonomers and one or more free-radical polymerization initiators are polymerized to produce a vinyl ester containing copolymer in a continuous or batch process at temperatures above 50° C. and at pressures above 1000 bar, known as high pressure polymerization systems. For example, a pressure of greater than 1000, 1100, 1200, 1500, 1600, 1700, 1800, 1900, 2000, 2100, 2200, 2300, 2400, 2500, 3000, 5000, or 10000 bar may be used. The vinyl ester containing copolymer, which may be a copolymer or a terpolymer, produced under high-pressure conditions may have number average molecular weights (Mn) of 1 to 10000 kDa, weight average molecular weights (Mw) of 1 to 20000 kDa. Molecular weight distribution (MWD) is obtained from the ratio between the weight average molecular weight (Mw) and the number average molecular weight (Mn) obtained by GPC. Copolymers and terpolymers produced under high-pressure conditions may have MWDs of 1 to 60. The GPC experiments may be carried out by analytical methods such as gel permeation chromatography coupled with triple detection, with an infrared detector IR5 and a four bridge capillary viscometer, both from PolymerChar and an eight angle light scattering detector from Wyatt. A set of 4 column, mixed bed, 13 μm from Tosoh in a temperature of 140° C. may be used. Conditions of the experiments may be: concentration of 1 mg/mL, flow rate of 1 mL/min, dissolution temperature and time of 160° C. and 90 minutes, respectively and an injection volume of 200 μL. The solvent used is TCB (Trichloro benzene) stabilized with 100 ppm of BHT.

In one or more embodiments, the conversion during polymerization in low pressure polymerization and high pressure polymerization systems, which is defined as the weight or mass flow of the produced polymer divided by the weight of mass flow of monomers and comonomers may have a lower limit of any of 0.01%, 0.1%, 1%, 2%, 5%, 7%, 10% and an upper limit of any of 15%, 17%, 20%, 25%, 30%, 35%, 40%, 45%, 50%, 60%, 70%, 80%, 90%, 99% or 100%, where any lower limit may be paired with any upper limit.

Additives

Polymer compositions in accordance with the present disclosure may include fillers and additives that modify various physical and chemical properties added to the polymer composition during blending. In one or more embodiments, the polymer composition may include one or more polymer additives such as kickers, processing aids, lubricants, antistatic agents, clarifying agents, nucleating agents, beta-nucleating agents, slipping agents, antioxidants, antacids, light stabilizers such as HALS, IR absorbers, whitening agents, organic and/or inorganic dyes, anti-blocking agents, processing aids, flame-retardants, plasticizers, biocides, and adhesion-promoting agents, pigments, fillers, reinforcements, adhesion-promoting agents, biocides, whitening agents, anti-blocking agents, processing aids and plasticizers.

In one or more embodiments, polymer compositions may include one or more inorganic fillers such as calcium carbonate, talc, glass fibers, marble dust, cement dust, clay, carbon black, feldspar, silica or glass, fumed silica, silicates, calcium silicate, silicic acid powder, glass microspheres, mica, metal oxide particles and nanoparticles such as magnesium oxide, antimony oxide, zinc oxide, inorganic salt particles and nanoparticles such as barium sulfate, wollastonite, alumina, aluminum silicate, titanium oxides, calcium carbonate, polyhedral oligomeric silsesquioxane (POSS).

In one or more embodiments, polymer compositions may contain a percent by weight of the total composition (wt %) of one or more additives and/or fillers that ranges from a lower limit selected from any of 0.01 wt %, 0.02 wt %, 0.05 wt %, 1.0 wt %, 5.0 wt %, 10.0 wt %, 15.0 wt %, and 20.0 wt %, to an upper limit selected from any of 25 wt %, 30 wt %, 40 wt %, 50 wt %, 60 wt %, and 70 wt %, where any lower limit can be used with any upper limit.

### Physical Properties of Polymer Compositions

In one or more embodiments, the polymer composition has an instrumented dart impact (IDI) puncture energy at −20° C. of equal or greater than about 10 ft-lb, such as equal or greater than 10, 15 and 20 ft-lbs, when tested according to ASTM D3763.

In one or more embodiments, the polymer compositions may have a percent increase in instrumented dart impact (IDI) puncture energy at −20° C. equal or greater than about 10%, when tested according to ASTM D3763. The percent increase in IDI puncture energy refers to as the percent difference in IDI puncture energy of the polymer composition and that of the corresponding propylene-based polymer, based on the IDI puncture energy of the propylene-based polymer. In one or more embodiments, the polymer composition may have a percentage increase in IDI puncture energy at −20° C. of at least 10%, 12.5%, 15%, 17.5% and 20%.

In one or more embodiments, the polymer compositions may have a melt flow rate (MFR) according to ASTM D1238, Procedure B, Condition 230° C./2.16 kg in a range having a lower limit selected from any of 0.1 g/10 min, 0.5 g/10 min, 1 g/10 min, 10 g/10 min, 15 g/10 min, 50 g/10 min, and 100 g/10 min, to an upper limit selected from any of 30 g/10 min, 200 g/10 min, 300 g/10 min, 500 g/10 min, and 1000 g/10 min where any lower limit may be paired with any upper limit.

In one or more embodiments, the polymer compositions may have a glass transition temperature (Tg) measured by dynamic mechanical analysis (DMA) or according to ASTM D3418 by DSC that ranges from a lower limit selected from any of −50° C., −45° C., and −40° C., to a lower limit selected from any of 30° C., 35° C., and 40° C., where any lower limit may be paired with any upper limit.

In one or more embodiments, the polymer compositions may have a density according to ASTM D792 in a range having a lower limit selected from any of 0.85 g/cm³, 0.90 g/cm³, and 0.90 g/cm³, to an upper limit selected from any of 1.20 g/cm³, 1.25 g/cm³, and 1.30 g/cm³, where any lower limit may be paired with any upper limit.

In one or more embodiments, the polymer composition has a tensile stress at yield (yield stress) according to ASTM D638 equal to or greater than about 5 MPa. In one or more embodiments, the polymer composition has a tensile stress at yield that ranges from a lower limit selected from any of 5 MPa, 6 MPa and 7 MPa to an upper limit selected from any of 40 MPa, 50 MPa, 100 MPa, and 200 MPa, where any lower limit may be paired with any upper limit.

In one or more embodiments, the polymer composition has a tensile stress at break (break stress) according to ASTM D638 equal to or greater than about 5 MPa. In one or more embodiments, the polymer composition has a tensile stress at break that ranges from a lower limit selected from any of 5 MPa, 6 MPa and 7 MPa to an upper limit selected from any of 40 MPa, 50 MPa, 100 MPa, and 200 MPa, where any lower limit may be paired with any upper limit.

In one or more embodiments, the polymer composition has a tensile modulus (tangent modulus) according to ASTM D638 that ranges from a lower limit selected from any of 0.1 GPa, 0.2 GPa, 0.3 GPa, 0.4 GPa and 0.5 GPa to an upper limit selected from any of 3 GPa, 3.5 GPa, 4.0 GPa, and 5.0 GPa, where any lower limit may be paired with any upper limit.

In one or more embodiments, the polymer composition has a yield strain according to ASTM D638 equal to or greater than about 2%. In one or more embodiments, the polymer composition has a yield strain that ranges from a lower limit selected from any of 2%, 3%, 4% and 5%, to an upper limit selected from any of 10%, 15%, 20%, 30%, 50% and 100%, where any lower limit may be paired with any upper limit.

In one or more embodiments, the polymer composition has a break strain according to ASTM D638 equal to or greater than about 50%. In one or more embodiments, the polymer composition has a break strain that ranges from a lower limit selected from any of 50%, 60%, and 70%, to an upper limit selected from any of 500%, 600%, 700% 1000% and 2000%, where any lower limit may be paired with any upper limit.

In one or more embodiments, the polymer compositions has a flexural modulus secant at 1% according to ASTM D790 equal to or greater than about 100 MPa. In one or more embodiments, the polymer composition may have a flexural modulus secant at 1% that ranges from a lower limit selected from any one of 100 MPa, 150 MPa, and 200 MPa, to an upper limit selected from any one of 850 MPa, 900 MPa, 950 MPa, 1000 MPa, 1500 MPa, and 2000 MPa, where any lower limit may be paired with any upper limit.

In one or more embodiments, the polymer composition has a Rockwell hardness of at least 25. In one or more embodiments, the polymer composition has a Rockwell hardness in a range of about 25 to 100, such as a lower limit selected from any one of 25 and 30, to an upper limit selected from any one of 70, 80, 90 and 100, where any lower limit may be paired with any upper limit.

In one or more embodiments, the polymer composition has a heat deflection temperature (HDT) of at least 50° C. when tested under ASTM D648 at a load of 66 psi. In one or more embodiments, the polymer composition has a heat deflection temperature of at least 50, 60, 70 and 80° C.

In one or more embodiments, the polymer composition may include a bio-based carbon content, as determined by ASTM D6866-18 Method B, in a range having a lower limit selected from any of 1%, 5%, 10%, and 20%, to an upper limit selected from any of 60%, 80%, 90%, and 100%, where any lower limit may be paired with any upper limit.

### Polymer Composition Preparation Methods

Polymer compositions in accordance with the present disclosure may be prepared by a number of possible polymer blending and formulation techniques.

In one or more embodiments, the polymer compositions may be produced by mixing a polypropylene-based polymer and a vinyl ester containing copolymer in a melt blend process. In one or more other embodiments, the polypropylene-based polymer and the vinyl ester containing copolymer are combined in a dry blend process, forming a powder blend of the polypropylene-based polymer and the vinyl ester containing copolymer, which may be particularly useful in additive manufacturing.

In one or more embodiments, the polymer compositions may be mixed in a batch, semi-continuous or continuous process, such as continuous or discontinuous extrusion. In one or more embodiments, the extrusion may include single-, twin- or multi-screw extruders.

In one or more embodiments, the polymer compositions may be mixed at temperatures ranging from about 20° C. to 300° C., such as a lower limit selected from any of 20° C., 30° C., 40° C., 50° C. to an upper limit of 250° C., 260° C., 280° C. and 300° C., where any lower limit may be paired with any upper limit.

In one or more embodiments, all components may be mixed together in a single step. In other embodiments, when more than one polypropylene-based polymer and/or vinyl ester containing copolymer are present in the polymer composition, there may be pre-mixing steps with selected components prior to a mixture with remaining components in a subsequent mixing step.

Applications

In one aspect, present disclosure relates to an article comprising the polymer composition. In one or more embodiments, the article may be an injection molded article, a thermoformed article, a film, a foam, a blow molded article, an additive manufactured article, a compressed article, a coextruded article, a laminated article, an injection blow molded article, a rotomolded article, an extruded article, monolayer articles, multilayer articles, or a pultruded article, and the like.

In one or more embodiments, the article comprising the polymer composition may be prepared by a process including, but not limited to, extrusion molding, coextrusion molding, extrusion coating, injection molding, compression blow forming, compression molding, injection blow molding, injection stretch blow molding, thermoforming, cast film extrusion, blown film extrusion, blown film process, foaming, extrusion blow molding, injection stretched blow molding, rotomolding, pultrusion, calendering, additive manufacturing, lamination.

### EXAMPLES

The following examples are provided to illustrate embodiments of the present disclosure. The Examples are not intended to limit the scope of the present invention, and they should not be so interpreted.

Various exemplary polymer compositions were produced based on two polypropylene heterophasic copolymers, ICP1 and ICP2, as the propylene-based polymer, and two vinyl ester containing copolymers, DV001A and DV002B (“Modifiers”). ICP1 and ICP2 are polypropylene-based polymer generally used in automotive compounding industry. The constituents and properties of the ICP1 and ICP2 are shown in Table 1. Xylene solubles in Table 1 represent the quantity of rubber phase in the propylene-based polymer, and the melt flow rate in Table 1 was obtained according to ASTM D1238, Procedure B, Condition 230° C./2.16 kg, as previously described.

TABLE 1

| | ICP1 | ICP2 |
|---|---|---|
| Xylene solubles (wt %) | 30 | 14 |
| Melt Flow Rate (g/10 min.) | 11 | 35 |

The constituents and properties of DV001A and DV001B are shown in Table 2. DV001A includes 5 wt % VeoVa™ branched vinyl ester comonomer, 19 wt % vinyl acetate (VA) and the remainder is ethylene. DV002B includes 9 wt % VeoVa™ branched vinyl ester comonomer, 23 wt % vinyl acetate and the remainder is ethylene. The comonomer content was determined by NMR.

TABLE 2

| | | | | Melt | Flexural |
|---|---|---|---|---|---|
| | | MFR | T_{g} | temperature | modulus |
| Modifier | Monomers | g/10 min | ° C. | ° C. | MPa |
| DV001A | 5% VeoVa | 6.9 | −21.4 | 71 | 24 |
| | 19% VA | | | | |
| DV001B | 9% VeoVa | 5 | −21.6 | 74 | 25 |
| | 23% VA | | | | |

MFR represents melt flow index or melt flow rate, which was determined as per ASTM D1238 as previously described. Flex modulus was determined by testing injection molded bars using ASTM D790 at room temperature. Glass transition temperature (Tg) was determined using dynamic mechanical analysis (DMA) temperature sweep at a frequency of 1 Hz, from a temperature of −150° C. to 90° C. following ASTM D4065. Melt temp was determined from dynamic scanning calorimetry (DSC). Samples were annealed at 200° C. Then scanned from 200° C. to 45° C. back to 200 at a ramp rate of 10° C./min.

### Example 1

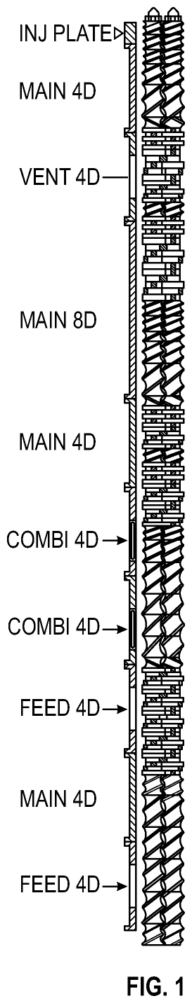

An exemplary polymer composition was produced by compounding 10 wt % DV001A, 10 wt % talc, 3000 ppm B225 antioxidant, and the remainder ICP1 at a temperature of 200° C. in ZSK-25 extruder as shown in FIG. 1. Talc generally helps disperse elastomers in high melt flow matrix and the antioxidant helps prevent the degradation of the polymer during the compounding process.

### Example 2

An exemplary polymer composition EXAMPLE 2 was produced as described in EXAMPLE 1 except that DV001A was replaced by DV001B.

### Example 3

An exemplary polymer composition EXAMPLE 3 was produced as described in EXAMPLE 1 except that ICP1 was replaced by ICP2.

### Example 4

An exemplary polymer composition EXAMPLE 4 was produced as described in EXAMPLE 1 except that ICP1 was replaced by ICP2, and DV001A was replaced by DV001B.

### Example 5

An exemplary polymer composition EXAMPLE 5 was produced as described in EXAMPLE 1 except that ICP1 was replaced by ICP2, and 10 wt % of DV001A was replaced by 20 wt % of DV001A.

### Example 5

An exemplary polymer composition EXAMPLE 6 was produced as described in EXAMPLE 1 except that ICP1 was replaced by ICP2, and 10 wt % of DV001A was replaced by 20 wt % of DV001B.

### Reference Example 1

Unmodified ICP1 was used as a REFERENCE EXAMPLE 1 to compare the properties to those of EXAMPLES 1-6.

### Reference Example 2

Unmodified ICP2 was used as a REFERENCE EXAMPLE 2 to compare the properties to those of EXAMPLES 1-6.

The melt flow rate of EXAMPLES 1-6 (EX 1-6) and REFERENCE EXAMPLES 1-2 (RE 1-2) were obtained according to ASTM D 1238 as previously described. The results are summarized in Table 3:

TABLE 3

| | Propylene-based | | Melt Flow Rate |
|---|---|---|---|
| | polymer | Modifier | (g/10 min) |
| EX 1 | ICP1 | 10% DV001A | 9.5 |
| EX 2 | ICP1 | 10% DV001B | 8.5 |
| EX 3 | ICP2 | 10% DV001A | 26 |
| EX 4 | ICP2 | 10% DV001B | 25.2 |
| EX 5 | ICP2 | 20% DV001A | 28.1 |
| EX 6 | ICP2 | 20% DV001B | 24.5 |
| RE 1 | ICP1 | | 8.4 |
| RE 2 | ICP2 | | 28.7 |

Physical and mechanical properties of EXAMPLES 1-6 and REFERENCE EXAMPLES 1-2 were obtained by conducting the tests as described below.

The tensile stress at break and at yield, yield strain, break strain, and tensile modulus (tangent modulus) were determined according to ASTM D638. The flexural modulus secant at 1% was determined according to ASTM D790. The instrumented dart impact puncture energy was determined according to ASTM D3763 at −20° C. Rockwell hardness was determined according to ASTM D785. HDT was determined according to ASTM D648 at 66 psi.

Tables 4-1 and 4-2 are a summary of the physical/mechanical properties of EXAMPLES 1-6 and REFERENCE EXAMPLES 1-2:

TABLE 4-1

| Sample# | | Break | Break | Yield | Yield | Tangent |
|---|---|---|---|---|---|---|
| Units | Rockwell | Strain | Stress | Strain | Stress | Modulus |
| Condition | Hardness | % | MPa | % | MPa | MPa |
| EX 1 | 37.3 | 546.1 | 14.7 | 10.2 | 17.0 | 1010 |
| EX 2 | 35.6 | 535.2 | 14.9 | 10.6 | 16.9 | 1019 |
| EX 3 | 69.1 | 78.2 | 15.9 | 6 | 21.9 | 1419 |
| EX 4 | 68.6 | 73.9 | 15.6 | 6.1 | 21.2 | 1373 |
| EX 5 | 52.2 | 130.1 | 13.5 | 8.5 | 18.8 | 1081 |
| EX 6 | 52.2 | 143.4 | 13.7 | 8.8 | 18.8 | 1077 |
| RE 1 | 57.6 | 177.7 | 14.2 | 5.5 | 19.1 | 1543 |
| RE 2 | 86.3 | 37.7 | 20.3 | 3.9 | 25.4 | 2195 |

TABLE 4-2

| | Flex Modulus | HDT | Puncture Energy |
|---|---|---|---|
| | Units | | |
| | MPa | ° C. | ft-lbs |
| | Condition | | |
| Sample# | 1% secant | 66 psi | −20° C. |
| EX 1 | 831 | 74.5 | 25.3 |
| EX 2 | 830 | 73.7 | 26.9 |
| EX 3 | 1165 | 89.6 | 14.4 |
| EX 4 | 1154 | 87.2 | 21.7 |
| EX 5 | 924 | 81.1 | 13.7 |
| EX 6 | 915 | 81.3 | 19.1 |
| RE 1 | 1207 | 102.3 | 28.3 |
| RE 2 | 1682 | 123.4 | 4.6 |

Tables 4-1 and 4-2 show that the addition of DV001A and DV001B increased the puncture energy for the ICP2 based polymer compositions.

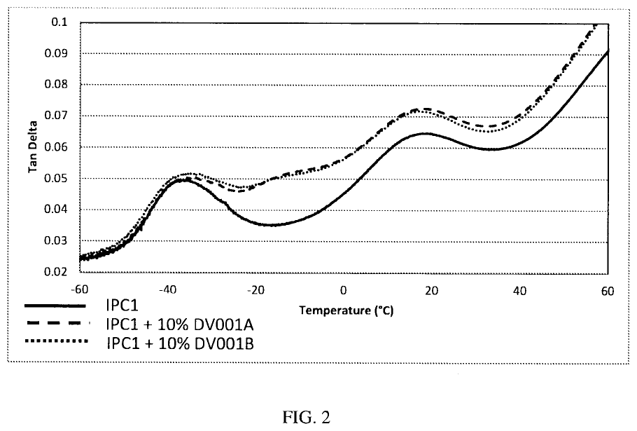

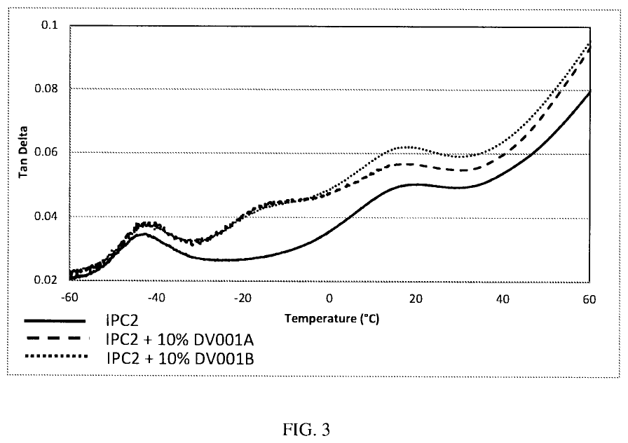

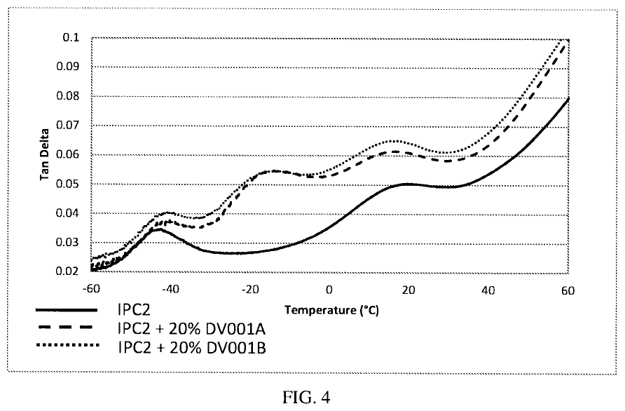

DMA temperature sweep test was conducted on EXAMPLES 1-6 and REFERENCE EXAMPLES 1-2 at a frequency of 1 Hz, and from a temperature of −150° C. to 90° C. DMA results of EXAMPLES 1-2 and REFERENCE EXAMPLE 1, EXAMPLES 3-4 and REFERENCE EXAMPLE 2, and EXAMPLES 5-6 and REFERENCE EXAMPLE 2, are shown in FIGS. 2-4, respectively.

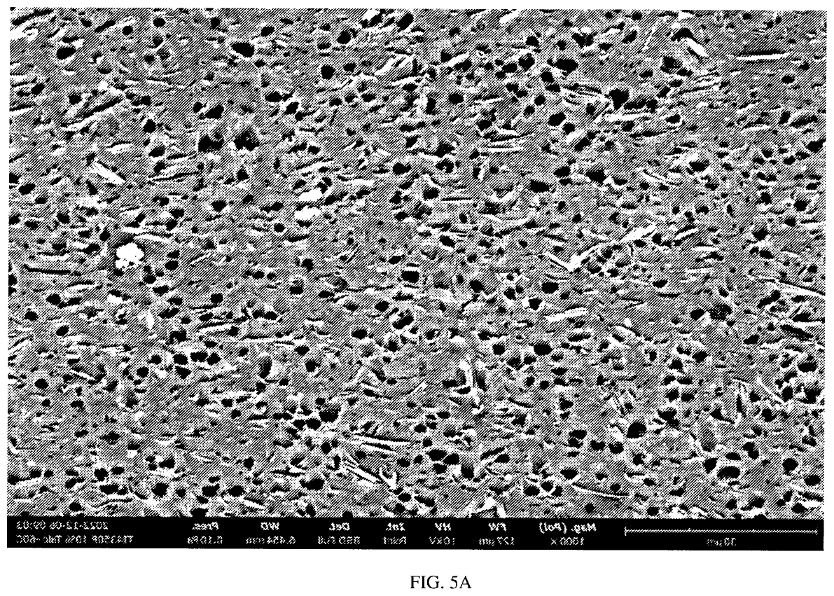

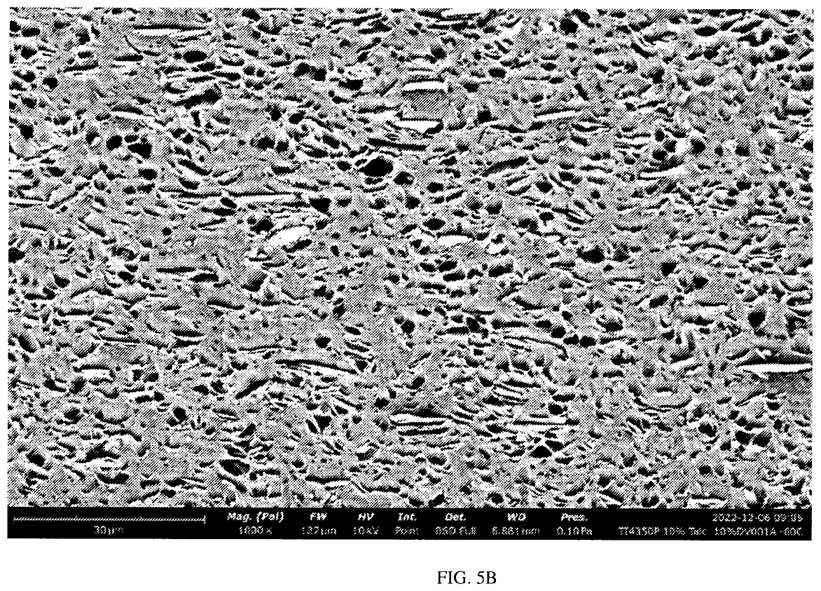

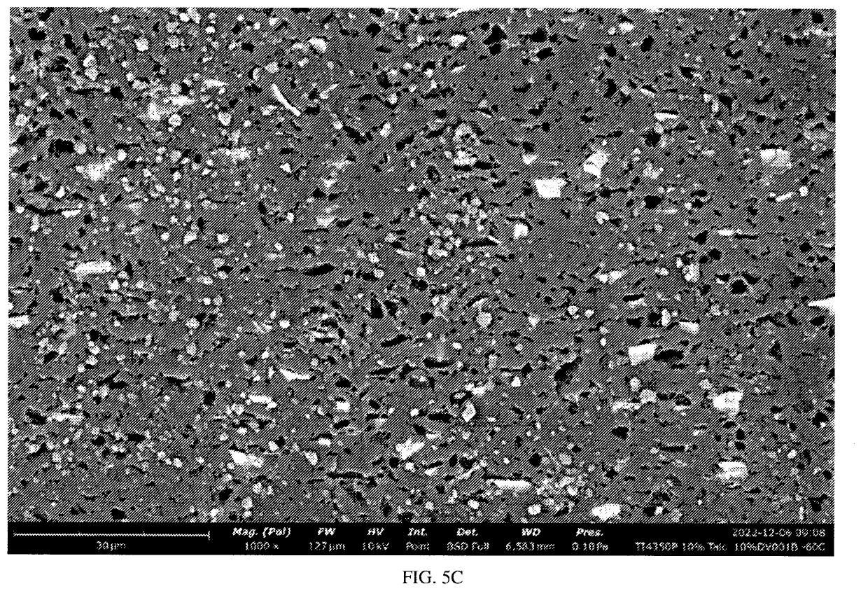

SEM images of REFERENCE EXAMPLE 2, EXAMPLE 3 and EXAMPLE 4 are shown in FIGS. 5A-C, respectively. The SEM images show similar sized rubber domains, indicating good dispersion of the rubber.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

What is claimed is:

1. A polymer composition, comprising:
a polypropylene-based polymer;
a vinyl ester containing copolymer comprising ethylene, one or more branched vinyl ester monomers, and optionally, vinyl acetate.

2. The polymer composition of claim 1, wherein the polypropylene-based polymer is a polypropylene homopolymer.

3. The polymer composition of claim 1, wherein the polypropylene-based polymer is a propylene copolymer comprising propylene and one or more comonomers selected from the group consisting of ethylene and C4 to C10 alpha-olefins.

4. The polymer composition of claim 1, wherein the polypropylene-based polymer is a heterophasic polypropylene.

5. The polymer composition of claim 1, wherein the polymer composition has a percent increase in instrumented dart impact puncture energy according to ASTM D3763 at −20° C. equal to or greater than 10%, when compared to a puncture energy of the polypropylene-based polymer at −20° C.

6. The polymer composition of claim 1, wherein the one or more branched vinyl ester monomers have the general structure (I): 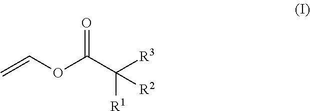
wherein R¹, R², and R³ have a combined carbon number of 3 to 20.

7. The polymer composition of claim 1, wherein the one or more branched vinyl ester monomers have the general structure (II): 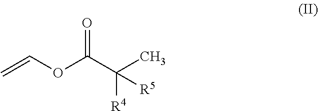
wherein R⁴ and R⁵ have a combined carbon number of 7.

8. The polymer composition of claim 1, wherein the vinyl ester containing copolymer is a copolymer consisting of ethylene and the one or more branched vinyl ester monomers.

9. The polymer composition of claim 1, wherein the vinyl ester containing copolymer is a terpolymer consisting of ethylene, the one or more branched vinyl ester monomers and vinyl acetate.

10. The polymer composition of claim 1, wherein the vinyl ester containing copolymer has a vinyl acetate content ranging from 0 to 50 wt %, based on a total amount of the vinyl ester containing copolymer in the polymer composition.

11. The polymer composition of claim 1, wherein the vinyl ester containing copolymer has the one or more branched vinyl ester monomers content ranging from 0.01 to 50 wt %, based on a total amount of the vinyl ester containing copolymer in the polymer composition.

12. The polymer composition of claim 1, wherein the polypropylene-based polymer is present at an amount ranging from 60 wt % to 99 wt %, based on a total amount of the polymer composition.

13. The polymer composition of claim 1, wherein the vinyl ester containing copolymer is present at an amount ranging from 1 wt % to 40 wt %, based on a total amount of the polymer composition.

14. The polymer composition of claim 1, wherein a melt flow rate (MFR) of the polymer composition according to ASTM D1238 at 230° C./2.16 kg ranges from 0.1 g/10 min to 1000 g/10 min.

15. The polymer composition of claim 1, wherein a glass transition temperature (Tg) of the polymer composition ranges from −50° C. to 40° C.

16. The polymer composition of claim 1, wherein the polymer composition exhibits a tensile stress at yield according to ASTM D638 equal to or greater than 5 MPa.

17. The polymer composition of claim 1, wherein the polymer composition exhibits a tensile stress at break according to ASTM D638 equal to or greater than 5 MPa.

18. The polymer composition of claim 1, wherein the polymer composition exhibits a tensile modulus according to ASTM D638 ranging from 0.1 to 5 GPa.

19. The polymer composition of claim 1, wherein the polymer composition exhibits a flexural modulus secant at 1% according to ASTM D790 equal to or greater than 100 MPa.

20. The polymer composition of claim 1, wherein the polymer composition exhibits a heat deflection temperature of at least 50° C.

21. The polymer composition of claim 1, wherein the polymer composition exhibits a break strain of at least 50%.

22. The polymer composition of claim 1, wherein the polymer composition exhibits a yield strain of at least 2%

23. The polymer composition of claim 1, wherein the polymer composition exhibits a Rockwell hardness of at least 25.

24. The polymer composition of claim 1, wherein the vinyl ester containing copolymer is polymerized under conditions comprising a reactor pressure of greater than 40 bar and a reactor temperature of greater than 50° C.

25. The polymer composition of claim 1, wherein the vinyl ester containing copolymer is polymerized under conditions comprising a reactor pressure of greater than 1000 bar and a reactor temperature of greater than 50° C.

26. The polymer composition of claim 1, further comprising one or more selected from the group consisting of antioxidants, pigments, fillers, reinforcements, adhesion-promoting agents, biocides, whitening agents, nucleating agents, anti-statics, anti-blocking agents, processing aids, flame-retardants, plasticizers, and light stabilizers.

27. A method for producing a polymer composition, the method comprising:
mixing a polypropylene-based polymer and a vinyl ester containing copolymer, at a temperature in a range from 20° C. to 300° C. to form a polymer composition, wherein the vinyl ester containing copolymer comprises ethylene, one or more branched vinyl ester monomers, and optionally, vinyl acetate.

28. The method of claim 27, wherein the mixing comprises melt mixing.

29. The method of claim 27, wherein the polymer composition is a powder mixture of the polypropylene-based polymer and the vinyl ester containing copolymer.

30. An article comprising the polymer composition of claim 1.

31. The article of claim 30, wherein the article is prepared by a method selected from a group consisting of extrusion molding, coextrusion molding, extrusion coating, injection molding, cast film extrusion, blown film extrusion, foaming, extrusion blow-molding, injection stretched blow-molding, rotomolding, pultrusion, calendering, additive manufacturing, and lamination.
